(19) United States
(12) Patent Application Publication
(10) Pub. No.: US 2025/0279080 A1
(43) Pub. Date: Sep. 4, 2025

(54) METHODS AND SYSTEMS FOR EXPLAINABLE INTERACTIVE GENERATION OF COMPOSITIONS

(71) Applicant: Sound Patrol, Inc., Los Angeles, CA (US)

(72) Inventors: Lamara De Brouwer, Malibu, CA (US); Walter Adolf De BROUWER, Malibu, CA (US); Geert TROOSKENS, Meise (BE); Benjamin Ray RESNICK, Plano, TX (US); John William THICKSTUN, lowa, IA (US); Percy LIANG, Stanford, CA (US); Warren FELDER, Los Angeles, CA (US); Vincent WING, Orange, CA (US); Lucas J KELLER, Los Angeles, CA (US)

(73) Assignee: Sound Patrol, Inc., Los Angeles, CA (US)

(21) Appl. No.: 18/667,665

(22) Filed: May 17, 2024

Related U.S. Application Data
(60) Provisional application No. 63/561,078, filed on Mar. 4, 2024.

(51) Int. Cl. G10H 1/00; G06F 40/284; G06F 40/40

(52) U.S. Cl. CPC G10H 1/0025; G06F 40/284; G06F 40/40; G10H 2210/111

(57) ABSTRACT

A computer-implemented method includes determining a set of s cluster summaries that are most similar to a natural language description of a new composition and generating the new composition based on s tokens corresponding to the set of s cluster summaries. Each cluster summary of the s cluster summaries corresponds to a cluster of similar compositions. The method may also include converting the natural language description to a set of composition attribute controls using an LLM and generating the new composition based on the set of composition attribute controls. The LLM may specify the set of composition attribute controls according to a JSON interface specification. Generating the new composition may include interleaving control events with generated events. The new composition may include one or more of music, art, graphical art, imagery, photography, video, prose, poetry, writing and literature. A corresponding system and computer program product are also disclosed herein.

### CROSS-REFERENCE TO RELATED APPLICATIONS

The present non-provisional patent application claims priority from (1) U.S. Provisional Application 63/561,078 filed on Mar. 4, 2024, which is incorporated herein by reference in their entirety and for all purposes as if completely and fully set forth herein.

### BACKGROUND

The subject matter disclosed herein relates to automated generation of compositions such as music.

Currently, systems and methods for automated generation of compositions are limited in their interactivity and provide little control and insight into the composition generation process.

### SUMMARY OF THE DISCLOSED EMBODIMENTS

One embodiment of a computer-implemented method for generating a new composition from a natural language description of the new composition determining a set of s cluster summaries that are most similar to a natural language description of the new composition, wherein each cluster summary of the set of s cluster summaries corresponds to a cluster of similar compositions and generating the new composition based on s tokens corresponding to the set of s cluster summaries.

The above method may also include displaying, to a user, the set of s cluster summaries, receiving the natural language description of the new composition from a user, embellishing the natural language description of the new composition using an LLM, converting the natural language description to a set of composition attribute controls using the LLM. Generating the new composition may be based on the set of composition attribute controls. The LLM may specify the set of composition attribute controls according to a JSON interface specification. The above method may include determining a distance between the target style vector and s style vector centroids corresponding to the s cluster summaries to produce s distances. Generating the new composition may be further based on the s distances. In some embodiments, s is greater than 1 and less than 6.

Generating the new composition may include interleaving control events with generated events. In some embodiments, the control events and the generated events correspond to musical notes and the musical notes comprise velocity information. The new composition may include one or more of music, art, graphical art, imagery, photography, video, prose, poetry, writing and literature.

Another embodiment of computer-implemented method for generating a new composition from a natural language description of the new composition may include clustering the set of N style vectors to produce a set of M style vector clusters and a set of M style vector centroids and generating a set of M cluster summaries corresponding to the set of M style vector clusters.

The above method may also include receiving a natural language description of a new composition, selecting s cluster summaries that are most similar to the natural language description of the new composition from the set of M cluster summaries, and generating, using a composition generation model, the new composition based on the style vector centroids corresponding to the s cluster summaries. Selecting the s cluster summaries may include encoding the natural language description of a new composition to produce a target style vector, determining which style vector centroids of the set of M style vector centroids are closest to the target style vector to produce a set of m closest style vector centroids and a corresponding set of m cluster summaries. In some cases, s is less than m and a large language model is used to select the s most similar cluster summaries from the set of m cluster summaries. In other cases, wherein s is equal to m.

The above method may include displaying, to a user, the s cluster summaries. In some embodiments, s is greater than 1 and less than 6. Each cluster summary of the set of M cluster summaries may be generated from natural language descriptions of compositions corresponding to a style vector cluster.

Another embodiment of a computer-implemented method for generating a new composition from a natural language description of the new composition may include receiving metadata for each composition of a set of N source compositions, using generative AI to generate, from the metadata, a set of N natural language descriptions corresponding to the set of N source compositions and training a composition generation model via the set of N source compositions and the set of N natural language descriptions. The method may also include receiving a natural language description of a new composition, generating the new composition using the composition generation model and the natural language description of the new composition. The new composition may include one or more of music, art, graphical art, imagery, photography, video, prose, poetry, writing and literature.

A system and computer program product corresponding to the above methods are also disclosed herein. The computer program product includes a computer readable storage medium having program instructions embodied therewith, wherein the computer readable storage medium is not a transitory signal per se, the program instructions executable by a processor to cause the processor to conduct the above methods. The system includes one or more processors and a computer-readable storage medium similar to the computer readable storage medium that is included in the computer program product.

### BRIEF DESCRIPTION OF THE DRAWINGS

In order that the advantages of the disclosed embodiments will be readily understood, a more particular description of the embodiments briefly described above will be rendered by reference to specific embodiments that are illustrated in the appended drawings. Understanding that these drawings depict only some embodiments and are therefore not to be considered to be limiting of scope, the embodiments will be described and explained with additional specificity and detail through the use of the accompanying drawings, in which:

FIG. 1 is a block diagram illustrating various portions of a computing environment in accordance with at least one embodiment disclosed herein;

FIG. 2 is a block diagram of one example of a system for interactive generation of compositions in accordance with at least one embodiment disclosed herein;

FIG. 3 is a flowchart of one example of a method for training and using a Composition Generation Model in accordance with at least one embodiment disclosed herein;

FIG. 4 is a flowchart of one example of a method for generating a new composition in accordance with at least one embodiment disclosed herein;

FIG. 5 is a flowchart of one example of a method for selecting cluster summaries in accordance with at least one embodiment disclosed herein;

FIGS. 6 and 7 are screenshots of a user interface for interactive generation of compositions in accordance with at least one embodiment disclosed herein; and

FIG. 8 is a block diagram illustrating one example of a computing stack in accordance with at least one embodiment disclosed herein.

### DETAILED DESCRIPTION OF THE DISCLOSED EMBODIMENTS

The technology and solutions disclosed herein enhance a user's creative control over a composition generation process.

One of ordinary skill in the art will appreciate that references throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

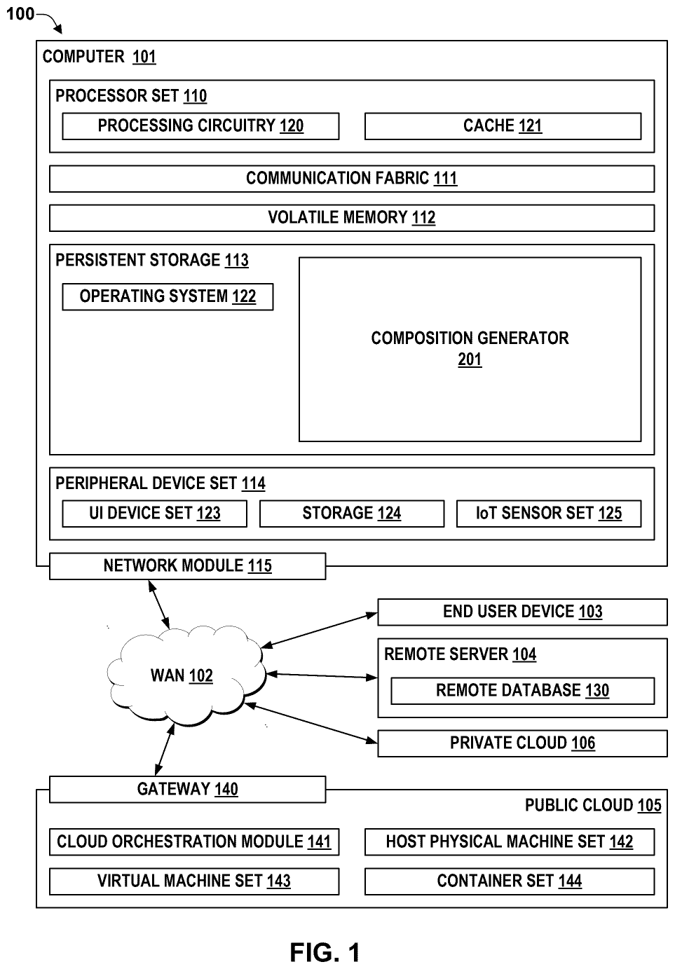

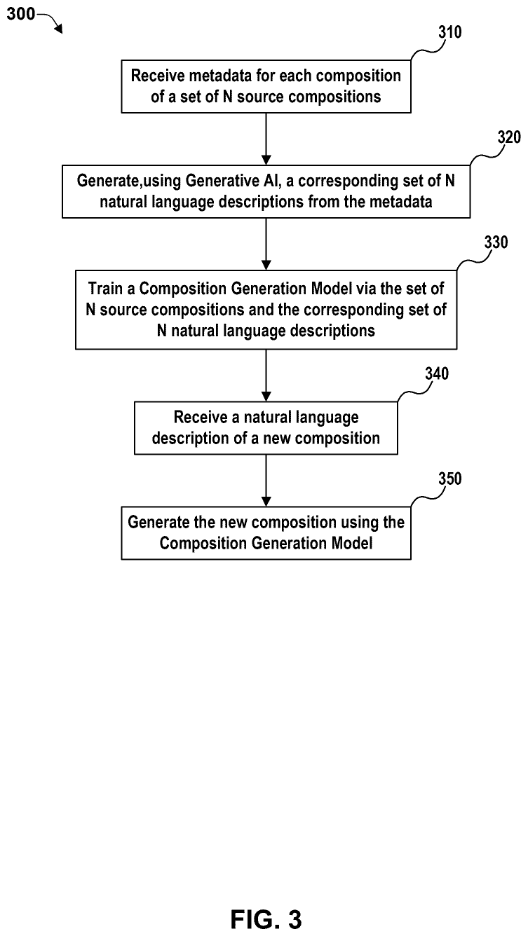

FIG. 1 is a block diagram illustrating various portions of a computing environment 100 in accordance with at least one embodiment disclosed herein. Computing environment 100 contains an example of an environment for the execution of at least some of the computer code involved in performing the inventive methods or processes, such as code block 201 (corresponding to the method 300 shown in FIG. 3). In some embodiments, portions of code block 201 reside within the operating system 122. In addition to block 201, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 201, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented process, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 201 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 201 typically includes at least some of the computer code involved in performing the inventive methods such as identifying data errors.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

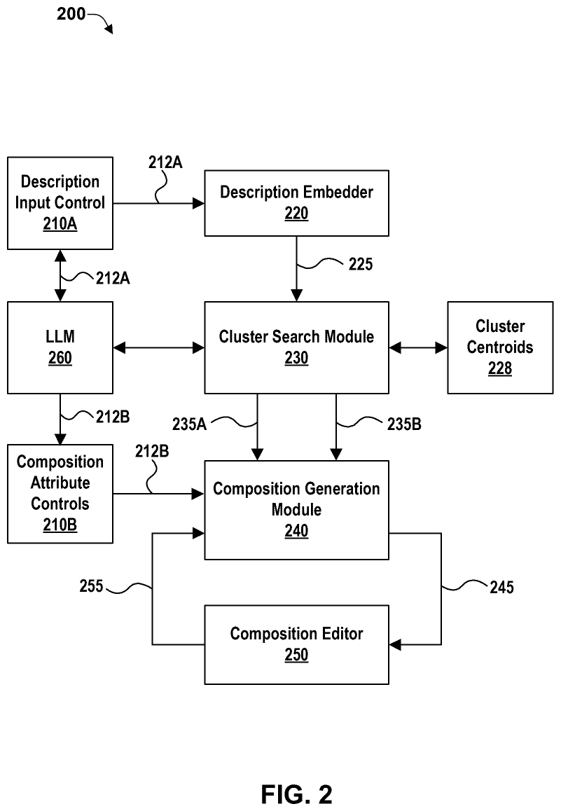

FIG. 2 is a block diagram of one example of a system 200 for interactive generation of compositions in accordance with at least one embodiment disclosed herein. As depicted, the system 200 includes user input controls 210, a description embedder 220, a cluster search module 230, a composition generation module 240. a composition editor 250 and a large language model (LLM) 260.

The user input controls 210 enable a user to influence or control the composition generation process. The depicted user interface controls 210 include a description input control 210A and composition attribute controls 210B. The description input control 210A enables a user to input a natural language description 212A of a new composition that is to be generated. The composition attribute controls 210B enable a user to specify specific desired attributes 212B for the composition.

Description embedder 220 converts the natural language description 212A to a target semantic vector 225. The cluster search module 230 searches M cluster centroids 228, finds a set of closest and/or most similar centroids and provides cluster tokens 235A corresponding to the closest centroids. The set of closest centroids may be the closest centroids or correspond to cluster summaries that are most similar to the natural language description of the new composition. The cluster search module 230 also calculates a distance between the target semantic vector 225 and each of the closest centroids and provides a set of distance tokens 235B corresponding to the calculated distances.

The composition generation module 240 receives the desired attributes 212B, the cluster tokens 235A and distance tokens 235B as composition control inputs and generates a new composition 245 according to those inputs. The composition generation module 240 may be an anticipatory transformer that uses a Composition Generation Model and interleaves input data with generated data.

The composition editor 250 enables a user to review and change the new composition 245 and provide an updated composition 255 to the composition generation module 240. Providing the updated composition 255 to the composition generation module 240 enables the user to iteratively augment and/or infill a composition using the composition generation module 240.

The LLM 260 can be leveraged to enhance the functionality of the system 200. For example, the LLM 260 may be used to embellish the natural language description of the new composition 212A with additional description such as adjectives and provide or fill in missing composition attribute controls 212B. For example, with a music composition the LLM may specify composition attribute controls 212B such as beats per minute, mood and musical simplicity/complexity. In some embodiments, the LLM 260 can receive an interface specification such as a JSON interface specification that enables the LLM 260 to specify the composition attributes 212B in a format understandable by the composition generation module 240. For example, in embodiments for music composition the JSON interface may specify a format for:
Musical Simplicity/Complexity
Note Density
Mood
Beats Per Minute
One or more Instruments/Voices to be Generated
One or more Style (i.e., Semantic) Vectors That Specify a Musical Style
Distance(s) to a Target Vector
Extending Song or Adding Instruments/Voices

FIG. 3 is a flowchart of one example of a method 300 for training and using a Composition Generation Model in accordance with at least one embodiment disclosed herein. As depicted, method 300 includes receiving (310) metadata, generating (320) natural language descriptions, training (330) the Composition Generation Model, receiving (340) a description of a new composition and generating (350) the new composition.

Receiving (310) metadata may include receiving metadata for each composition of a set of N source compositions. Generating (320) natural language descriptions may include generating, using Generative AI, a corresponding set of N natural language descriptions from the metadata. Using Generative AI may provide additional information on various compositions from sources used to train the Generative AI and thereby provide a more complete description of the composition than is available in the metadata. The additional information may originate from online reviews, blogs, social media sites and the like.

Training (330) a Composition Generation Model may include leveraging the set of N source compositions and the corresponding set of N natural language descriptions to provide a Composition Generation Model that is responsive to natural language descriptions or sematic representations thereof such as semantic (i.e., style) vectors. Receiving (340) a description of a new composition may include receiving a natural language description of the new composition. Generating (350) the new composition may include generating the new composition using the trained Composition Generation Model.

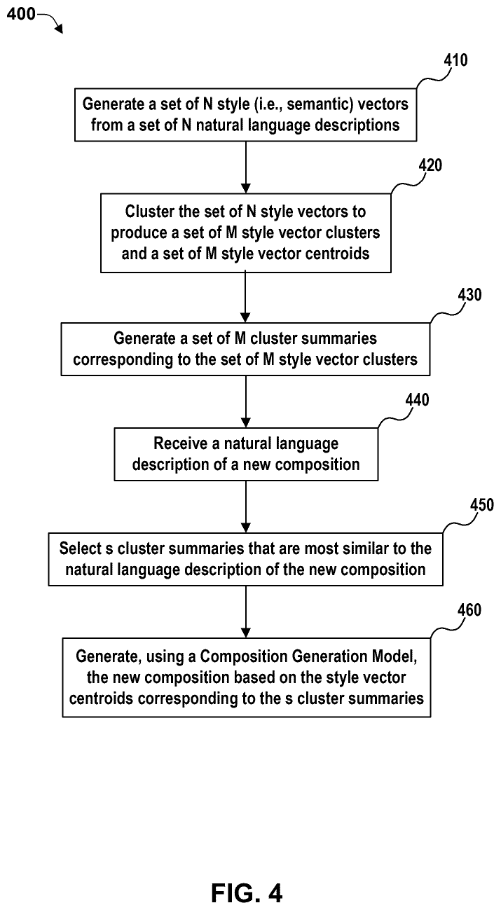

FIG. 4 is a flowchart of one example of a method 400 for generating a new composition in accordance with at least one embodiment disclosed herein. As depicted, the method 400 includes generating (410) a set of style (i.e., semantic) vectors, clustering (420) the set of style vectors, generating (430) cluster summaries, receiving (440) a description of a new composition, selecting (450) one or more cluster summaries and generating (460) the new composition.

Generating (410) a set of style vectors may include generating a set of N style vectors from a set of N natural language descriptions via a text embedding process. Clustering (420) the set of style vectors may include clustering the set of N style vectors to produce a set of M style vector clusters and finding the centroid of each style vector cluster to produce a set of M style vector centroids corresponding to the M style vector clusters.

Generating (430) one or more cluster summaries may include generating a summary for each style vector cluster of the set of M style vector clusters. Each summary may be generated by passing the natural language descriptions that correspond to a style vector cluster to a text summarization utility.

Receiving (440) a description of a new composition may include receiving a natural language description that describes desired attributes of the new composition. Selecting (450) one or more cluster summaries may include selecting the cluster summaries that a most similar to the natural language description of the new composition. In some embodiments, a fixed number of cluster summaries (e.g., 3) are selected.

Generating (460) the new composition may include generating, using a Composition Generation Model, the new composition based on (tokens corresponding to) the style vector centroids corresponding to the selected cluster summaries. The new composition may augment or infill an existing composition. By employing an iterative approach, the composer can explore various options and control the quality of the finished composition.

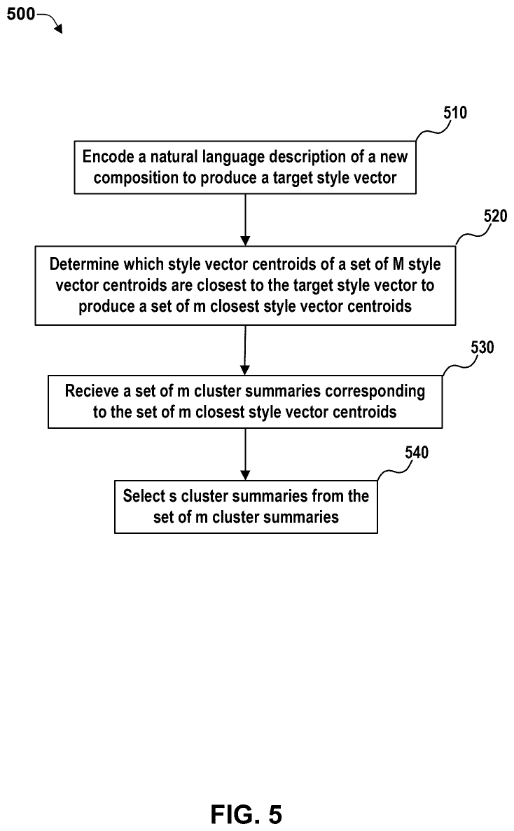

FIG. 5 is a flowchart of one example of a method 500 for selecting cluster summaries for generating a new composition. As depicted, the method 500 includes encoding (510) a natural language description to produce a target style (i.e., semantic) vector, determining (520) which style vector centroids are closest to the target style vector, receiving (530) a set of m cluster summaries corresponding to the set of m closest style vector centroids and selecting (540) s cluster summaries from the set of m cluster summaries. In one embodiment, s is less than 6 and m is greater than 8. Encoding (510) a natural language description may include using a text embedding utility to generate the target style vector.

One particular embodiment of the present invention is described below. The described embodiment is focused on generating musical compositions.

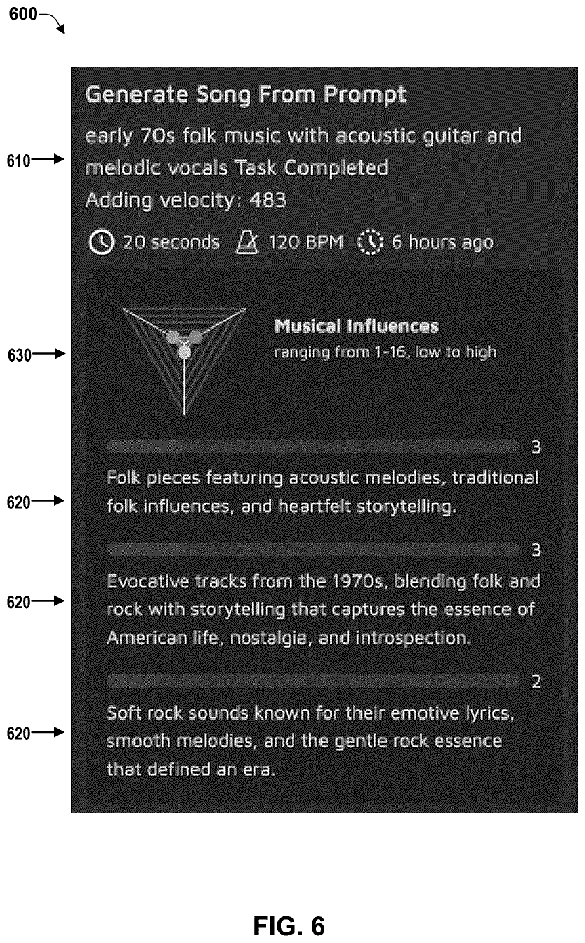

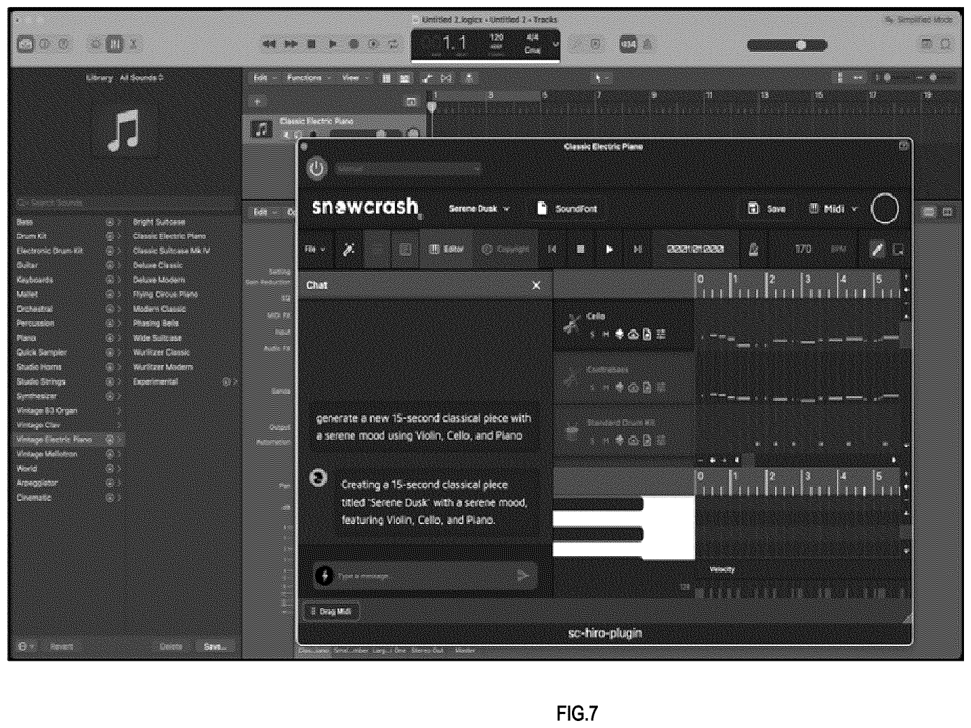

FIGS. 6 and 7 are screenshots of a user interface for interactive generation of musical compositions in accordance with at least one embodiment disclosed herein. As shown in FIG. 6 a natural language description 610 may be used to generate a target style vector (not shown). Multiple style cluster summaries 620 may be displayed to the user. The displayed summaries may correspond to the cluster centroids that are closest to the target style vector or most similar to the natural language description 610. The distances from the target style vector to the style vector centroids of the selected cluster summaries may be visually presented to the user. In the depicted embodiment, the distance is visually indicated via a influence rating shown on an influence triangle 630 and annotated to the right of the style cluster summaries 620.

As shown in FIG. 7 the generated composition may be provided to an editor such as a MIDI editor to enable the composer to review and improve the generated composition.

One implementation of the system integrates a sophisticated AI model, the Anticipatory Music Transformer, with proprietary developments in text conditioning, velocity prediction, and copyright checking, all orchestrated within a user-friendly plugin and web application interface. The system operates on a (Python) backend utilizing top tier GPUs, with a T3 stack on the frontend deployed on Vercel in a serverless manner. The music player component leverages Signal, an open source web-based MIDI editor and sound module.

A producer agent that operates between the user and the AI model is powered by a large language model and its understanding of song structures, instrument selection, and individual note variations is enhanced by its powerful Anticipatory music generation model. The Anticipatory model works much like any language model, except instead of predicting the “next word” it predicts the “next note”, allowing us to see a selected duration into the future. With this creative companion, artists and producers can become super producers, and explore new horizons in song composition. Leveraging the AI's grasp of musical theory and genre-specific nuances, producers can produce more efficiently while keeping on creating truly harmonious and innovative works.

Text Conditioning: To refine the interaction between user prompts and the AI's music generation capabilities, the system embeds a corpus of song-associated prompts using a text encoding neural network to generate an x-dimensional (semantic/style) vector representation. k-means clustering is used to organize these vectors into meaningful groups. Each natural language description of a new composition is converted to a target style vector and assigned to the m (e.g., three) clusters that are nearest to it. Cluster assignments are mapped to tokens. An additional “distance” token is also used for each cluster assignment to describe how far in embedding space the cluster centroid is from the target style vector. These tokens are then used to fine-tune the AI model.

This process enables the system to understand and respond to natural language commands more effectively, enhancing the user's creative control over the music generation process.

Velocity Prediction Model: To add dynamic expression to generated music, a velocity prediction predicts note velocities alongside note sequences, incorporating a notion of future/past in music generation. The model operates with minimal latency, offering an intuitive way to pair notes with their corresponding velocities, thereby enriching the musical output with nuanced dynamics. In one embodiment, this involves a post-processing step where the existing model is fine-tuned to simultaneously predict velocity as it generates note events. This enhancement introduces a fourth token for every note, enabling the model to anticipate velocities with an understanding of the musical context, both past and future. The goal is to accurately predict note velocities while considering the forthcoming notes, thereby adding a dynamic and expressive dimension to the generated music.

Plugin and Web App Functionalities: The described system is accessible both as a Digital Audio Workspace (DAW) plugin and a web application, offering a consistent set of features across platforms with some distinctions:

MIDI Mapping: The plugin version includes MIDI port mapping for automatic routing of the songs to 16 tracks in the DAW, enhancing accessibility and control for professional producers. Drag and Drop Functionality: Also exclusive to the plugin, this feature facilitates easy transfer of music files between Hiro and external DAWs.

Fully Equipped MIDI Editor: Users can orchestrate compositions using a multi-track piano roll editor, employing velocity.

Sound Module: A sound module supports importing third-party soundfonts (.sf2 files).as well as 128 virtual instruments for high-speed playback.

Ultra-Fast Audio File Export: Music created in Hiro can be saved as WAV files for versatile use across platforms and devices.

Advanced Composition Features: Direct interaction with the piano roll for song edits as well as many editing functions such as automatic song naming with the option for manual renaming.

Generate with Prompt (Text Conditioning): Users can generate new songs based on specific prompts (natural language descriptions), with the cluster based text conditioning. This function supports various genres, including metal, classical, videogame, EDM, jazz, and others.

Extend Song: This feature allows users to extend existing songs by specifying the desired length and genre, enabling seamless continuation of musical ideas.

Add Accompaniment: Users can add accompaniments to tracks, specifying start time, duration, main melody instrument, and genre, enriching the song's texture and complexity.

Update Song Name: Provides the flexibility to rename songs as desired, enhancing personalization and organization.

Delete Part/Remove Instrument: Offers the ability to remove specific parts or instruments from a song, allowing for precise editing and refinement.

Span Infilling: Reimagines specific sections of a song, offering creative variations and enhancements.

Edit Midi File: A versatile function that addresses user requests in a generic way when no other function fits, ensuring maximum flexibility.

Undo Last Change: Allows users to revert the last change made to the MIDI file, ensuring a safety net during the creative process.

By harnessing the power of the Anticipatory Music Transformer alongside cutting-edge developments in proprietary text conditioning, and copyright analysis, the system provides artists and producers with a robust platform for exploring new musical territories. Its intuitive interface, whether accessed through a Digital Audio Workspace plugin or a web application, ensures a seamless and productive user experience, catering to both the creative impulses and professional demands of its users.

A method for generating a new composition from a natural language description of the new composition includes determining a set of s cluster summaries that are most similar to a natural language description of a new composition, wherein each cluster summary of the set of s cluster summaries corresponds to a cluster of similar compositions; and generating the new composition based on s tokens corresponding to the set of s cluster summaries.

The above method may also include displaying, to a user, the set of s cluster summaries, receiving the natural language description of the new composition from a user, embellishing the natural language description of the new composition using an LLM, converting the natural language description to a set of composition attribute controls using an LLM. Generating the new composition may be based on the set of composition attribute controls. The LLM may specify the set of composition attribute controls according to a JSON interface specification.

The above method may include determining a distance between the target style vector and s style vector centroids corresponding to the s cluster summaries to produce s distances. Generating the new composition may be further based on the s distances. In some embodiments, s is greater than 1 and less than 6. Generating the new composition may include interleaving control events with generated events. In some embodiments, the control events and the generated events correspond to musical notes and the musical notes comprise velocity information. The new composition may include one or more of music, art, graphical art, imagery, photography, video, prose, poetry, writing and literature.

A method for generating a new composition from a natural language description of the new composition may include using generative AI to generate, from metadata for each composition of a set of N source compositions a natural language description of the composition to produce a set of N natural language descriptions, generating a style vector for each natural language description of the set of N natural language descriptions to produce a set of N style (i.e., semantic) vectors, clustering the set of N style vectors to produce a set of M style vector clusters and a set of M style vector centroid and generating a set of M cluster summaries corresponding to the set of M style vector clusters.

The above method may also include receiving a natural language description of a new composition, selecting s cluster summaries that are most similar to the natural language description of the new composition from the set of M cluster summaries, and generating, using a composition generation model, the new composition based on the style vector centroids corresponding to the s cluster summaries. Selecting the s cluster summaries may include encoding the natural language description of a new composition to produce a target style vector, determining which style vector centroids of the set of M style vector centroids are closest to the target style vector to produce a set of m closest style vector centroids and a corresponding set of m cluster summaries. In some cases, s is less than m and a large language model is used to select the s most similar cluster summaries from the set of m cluster summaries. In other cases, s is equal to m.

The above method may include displaying, to a user, the s cluster summaries. In some embodiments, s is greater than 1 and less than 6. Each cluster summary of the set of M cluster summaries may be generated from natural language descriptions of compositions corresponding to a style vector cluster.

A method for generating a new composition from a natural language description of the new composition may include may include receiving metadata for each composition of a set of N source compositions, using generative AI to generate, from the metadata, a set of N natural language descriptions corresponding to the set of N source compositions and training a composition generation model via the set of N source compositions and the set of N natural language descriptions. The method may also include receiving a natural language description of a new composition, generating the new composition using the composition generation model and the natural language description of the new composition. The new composition may include one or more of music, art, graphical art, imagery, photography, video, prose, poetry, writing and literature.

### Incorporation into a System and Computer Program Product

A system and computer program product corresponding to the above methods are also disclosed herein. Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

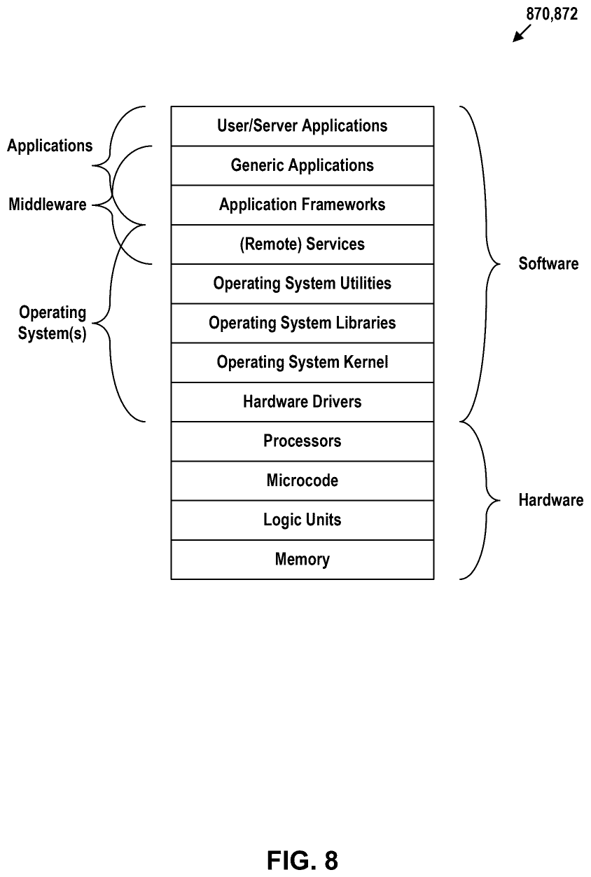

FIG. 8 is a block diagram illustrating one example of a computing stack 670 in accordance with at least one embodiment disclosed herein. As depicted, the computing stack 870 includes a number of computing layers 872 used for conducting computing operations. In the depicted embodiment, the layers include hardware layers and software layers. The various software layers include operating system layers associated with executing one or more operating systems, middleware layers associated with executing middleware that expands and/or improves the functionality of hardware layers, and executing operating system(s). The software layers may also include various application-specific layers. The application-specific layers may include application frameworks that further expand on, and/or improve upon, the functionality of hardware layers and operating system layers.

The memory layer may include volatile memory, non-volatile memory, persistent storage and hardware associated with controlling such memory. The logic units may include CPUs, arithmetic units, graphic processing units, and hardware associated with controlling such units. The microcode layer may include executable instructions for controlling the processing flow associated with moving data between memory and the logic units. The processor layer may include instruction fetch units, instruction decode units, and the like that enable execution of processing instructions and utilization of the underlying hardware layers.

The hardware drivers (also known as the hardware abstraction layer) may include executable code that enables an operating system to access and control storage devices, DMA hardware, I/O buses, peripheral devices, and other hardware associated with a computing environment. The operating system kernel layer may receive I/O requests from higher layers and manage memory and other hardware resources via the hardware drivers. The operating system kernel layer may also provide other functions such as inter-process communication and file management.

Operating system libraries and utilities may expand the functionality provided by the operating system kernel and provide an interface for accessing those functions. Libraries are typically leveraged by higher layers of software by linking library object code into higher level software executables. In contrast, operating system utilities are typically standalone executables that can be invoked via an operating system shell that receives commands from a user and/or a script file. Examples of operating system libraries include file I/O libraries, math libraries, memory management libraries, process control libraries, data access libraries, and the like. Examples of operating system utilities include anti-virus managers, disk formatters, disk defragmenters, file compressors, data or file sorters, data archivers, memory testers, program installers, package managers, network utilities, system monitors, system profilers, and the like.

Services are often provided by a running executable or process that receives local or remote requests from other processes or devices called clients. A computer running a service is often referred to as a server. Examples of servers include database servers, file servers, mail servers, print servers, web servers, game servers, and application servers.

Application frameworks provide functionality that is commonly needed by applications and include system infrastructure frameworks, middleware integration, frameworks, enterprise application frameworks, graphical rendering frameworks, and gaming frameworks. An application framework may support application development for a specific environment or industry. In some cases, application frameworks are available for multiple operating systems and providing a common programming interface to developers across multiple platforms.

Generic applications include applications that are needed by most users. Examples of generic applications include mail applications, calendaring and scheduling applications, and web browsers. Such applications may be automatically included with an operating system.

One of skill in the art will appreciate that an improvement to any of the depicted layers, or similar layers that are not depicted herein, results in an improvement to the computer itself including the computer 101 and/or the end user devices 103. One of skill in the art will also appreciate that the depicted layers are given by way of example are not representative of all computing devices. Nevertheless, the concept of improving the computer itself by improving one or more functional layers is essentially universal.

The executables and programs described herein are identified based upon the application or software layer for which they are implemented in a specific embodiment of the present invention. However, it should be appreciated that any particular program nomenclature herein is used merely for convenience, and thus the present invention should not be limited to use solely in any specific identified application or software layer.

The features, advantages, and characteristics of the embodiments described herein may be combined in any suitable manner. One skilled in the relevant art will recognize that the embodiments may be practiced without one or more of the specific features or advantages of a particular embodiment. In other instances, additional features and advantages may be recognized in certain embodiments that may not be present in all embodiments.

Some of the functional units described in this specification may have been labeled as modules, in order to more particularly emphasize their implementation independence. For example, a module may be implemented as a hardware circuit comprising custom vary large scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices, or the like.

Modules may also be implemented in software for execution by various types of processors. An identified module of program instructions may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

In the preceding description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, processes, components, materials, and so forth. In other instances, well-known structures, materials, or operations are not shown or described in detail to avoid obscuring aspects of an embodiment.

The description of elements in each figure may refer to elements of proceeding figures. Like numbers refer to like elements in all figures, including alternate embodiments of like elements. The embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A computer-implemented method comprising:
determining a set of s cluster summaries that are most similar to a natural language description of a new composition,
generating the new composition based on s tokens corresponding to the set of s cluster summaries; and
wherein each cluster summary of the set of s cluster summaries corresponds to a cluster of similar compositions.

2. The method of claim 1, further comprising displaying, to a user, the set of s cluster summaries.

3. The method of claim 1, further comprising embellishing the natural language description of the new composition using a large language model (LLM).

4. The method of claim 3, further comprising converting the natural language description to a set of composition attribute controls using the LLM.

5. The method of claim 4, wherein the new composition is generated based on the set of composition attribute controls.

6. The method of claim 4, wherein the set of composition attribute controls conform to a JSON interface specification.

7. The method of claim 1, further comprising determining a distance between the target style vector and s style vector centroids corresponding to the s cluster summaries to produce s distances and generating the new composition based on the s distances.

8. The method of claim 1, wherein generating the new composition comprises interleaving control events with generated events.

9. The method of claim 1, wherein the new composition comprises one or more of music, art, graphical art, imagery, photography, video, prose, poetry, writing and literature.

10. A computer-implemented method comprising:
clustering a set of N style vectors to produce a set of M style vector clusters and a set of M style vector centroids;
generating a set of M cluster summaries corresponding to the set of M style vector clusters;
receiving a natural language description of a new composition;
selecting s cluster summaries that are most similar to the natural language description of the new composition from the set of M cluster summaries; and
generating, from a composition generation model, the new composition based on the style vector centroids corresponding to the s cluster summaries.

11. The method of claim 10, further comprising using generative AI to generate, from metadata for each composition of a set of N source compositions a natural language description of the composition to produce a set of N natural language descriptions.

12. The method of claim 11, further comprising generating a style vector for each natural language description of the set of N natural language descriptions to produce the set of N style vectors.

13. The method of claim 12, further comprising clustering the set of N style vectors to produce a set of M style vector clusters and a set of M style vector centroids and generating a set of M cluster summaries corresponding to the set of M style vector clusters.

14. The method of claim 13, wherein the set of s cluster summaries are selected from the set of M cluster summaries.

15. The method of claim 10, further comprising displaying, to a user, the s cluster summaries.

16. The method of claim 10, wherein the new composition comprises one or more of music, art, graphical art, imagery, photography, video, prose, poetry, writing and literature.

17. A computer-implemented method comprising:
receiving metadata for each composition of a set of N source compositions;
using generative AI to generate, from the metadata, a set of N natural language descriptions corresponding to the set of N source compositions; and
training a composition generation model via the set of N source compositions and the set of N natural language descriptions.

18. The method of claim 17, further comprising receiving a natural language description of a new composition.

19. The method of claim 18, generating the new composition using the composition generation model and the natural language description of the new composition.

20. The method of claim 19, wherein the new composition comprises one or more of music, art, graphical art, imagery, photography, video, prose, poetry, writing and literature.
